(19) United States
(12) Patent Application Publication
(10) Pub. No.: US 2026/0287504 A1
(43) Pub. Date: Sep. 24, 2026

(54) Tunable laser spectroscopy system with narrow-range scanning and auto-balanced detection

(71) Applicant: KineoLabs, Inc., Billerica, MA (US)

(72) Inventor: Nathaniel Houston, San Francisco, CA (US)

(21) Appl. No.: 19/535,482

(22) Filed: Feb. 10, 2026

Related U.S. Application Data
(60) Provisional application No. 63/756,486, filed on Feb. 10, 2025.
(60) Provisional application No. 63/756,495, filed on Feb. 10, 2025.

(51) Int. Cl. G01N 21/39

(52) U.S. Cl. CPC G01N 21/39; G01N 2021/396

(57) ABSTRACT

A tunable laser absorption spectroscopy system includes a tunable laser, a splitter forming a signal beam through a sample and a reference beam, and first and second photodetectors producing signal and reference photocurrents. An auto-balanced detector subtracts a scaled reference photocurrent from the signal photocurrent and uses an integrating feedback loop to adjust the scaling to cancel DC and/or low-frequency common-mode intensity noise. The laser may be a cat's-eye external-cavity laser with a tilt-tuned interference filter scanned over a selected wavelength window, including narrow scans. A fractional current-mirror tap diverts a fraction of the reference photocurrent to generate a power-monitor signal for laser drive-current control without an added optical pickoff.

### RELATED APPLICATIONS

This application claims the benefit under 35 USC 119(e) of U.S. Provisional Application No. 63/756,486, filed on Feb. 10, 2025, and U.S. Provisional Application No. 63/756,495, filed on Feb. 10, 2025, both of which are incorporated herein by reference in their entireties.

### BACKGROUND OF THE INVENTION

Absorption spectroscopy measures the presence and/or concentration of a species of interest in a sample by passing a light beam through the sample and detecting the absorption at wavelengths of a particular spectral absorption feature of the species of interest. Generally, such a feature is an absorption line that represents the frequency of light corresponding to vibrational, rotational, or electronic transitions of molecules of the gas or liquid of interest. Tunable narrow-band sources such as lasers provide many advantages for such absorption spectroscopy measurements in that the lasers can be tuned to the center of a spectral feature and generate a narrow spectral signal relative to the width of the spectral feature.

Laser absorption spectroscopy can offer high speed and relatively high precision capabilities for detecting a variety of species in gas or liquid samples. Tunable diode laser spectrometers are often used for high-sensitivity studies, in part, because they may be frequency-modulated to reduce low-frequency laser noise and electronic noise. In general, a laser spectrometer will include a frequency tunable laser that generates an illumination output beam directed through a sample cell that contains a sample. The output beam is then directed to an optical detector, and the signal from the optical detector is demodulated to obtain an absorption-induced signal. This absorption-induced signal can be used to identify one or more species of interest within the sample and otherwise determine the constituents of the sample.

### SUMMARY OF THE INVENTION

Certain tunable laser spectroscopy systems have been designed to scan relatively broad wavelength ranges—for example, on the order of 100 nm or more—to accommodate multiple spectral bands or to interrogate multiple gas lines. However, numerous applications require detecting fewer species or narrower absorption features. For such applications, sweeping a large bandwidth can introduce additional noise, reduce sweep speed, and complicate detection electronics.

Common-mode noise, such as intensity fluctuations from the laser source or environmental noise affecting both the signal and reference paths, can also limit the achievable signal-to-noise ratio. Consequently, a need exists for a tunable laser architecture that targets a spectral window for specific measurements while incorporating a noise-reduction strategy to minimize common-mode noise and improve sensitivity.

In some embodiments, a tunable or swept laser architecture suitable for high-sensitivity spectroscopy of trace gases or other species with narrow absorption lines operates within a limited wavelength band, such as less than 15 nanometers and often less than 10 nm and currently 5 nm, but often more than 1 nm and usually greater than 2 nm.

In other embodiments, the laser architecture operates within wider wavelength bands.

In either case, the system preferably employs a cat's-eye external cavity laser configuration and includes an auto-balanced detector circuit for improved noise performance.

In one embodiment, the tunable laser utilizes a semiconductor gain chip, preferably a single angled facet (SAF) edge-emitting gain chip, which defines one end of the external cavity with its reflective surface acting as the rear mirror. An external reflector or partial mirror at the opposite end serves as an output coupler or intra cavity output couplers are possible. Between these elements, a transmissive tilt-tuned interference filter is arranged in a cat's-eye configuration to set and sweep the lasing wavelength. Some designs scan a broad spectrum (e.g., ~200 nm or more), whereas other designs narrow the sweep range to approximately 50 nm or less. Some designs perform a combination of broad spectrum and narrowing sweeping. By reducing the range of angular motion required on the interference filter (e.g., via a galvanometer), the system interrogates a smaller set of target absorption features more efficiently.

One advancement of this invention is the integration of an auto-balanced detector circuit that reduces common-mode noise. The circuit is based on an analog subtraction approach, wherein the optical beam is split into a signal arm that passes through the sample and a reference arm that bypasses the sample. Both arms are then sent to a dual photodiode configuration whose outputs are processed by a low-noise analog subtraction circuit to counteract random intensity noise and other correlated fluctuations in the laser source. Experimental results indicate a common-mode noise reduction of about 55 dB in the frequency range of interest, from approximately 500 Hz to 50 kHz.

When limiting the swept wavelength region to the spectral window of interest, the galvanometer can cycle the interference filter angle at a higher repetition rate. This higher repetition rate allows multiple scans per unit time over the narrower wavelength range, enabling enhanced time-domain averaging and further improving measurement precision. Combined with auto-balanced detection, this approach can provide gains in signal-to-noise ratio (SNR) for trace species detection.

In exemplary applications, the invention is useful for detecting gases such as methane, ethylene oxide, and hydrogen sulfide—species with narrow absorption features in the near-infrared (NIR) region. The cat's-eye external cavity configuration employs an angled-facet gain chip. Control software and data analysis routines include normalization, linear slope correction, and averaging algorithms that benefit from the increased scan repetition rate.

The technique can be applied in fields including chemical sensing, environmental monitoring, medical diagnostics, and industrial process control. The auto-balanced detection strategy is not limited to a single circuit topology; other variations may achieve similar noise cancellation.

In addition, many spectroscopy applications also require active control of the laser output power to reduce broad sloping backgrounds in the measured absorption signal. These backgrounds, caused by factors such as laser intensity drift and slow frequency shifts, can mask absorption features and affect long-term averaging. In conventional designs, a separate photodiode and beamsplitter may be used to monitor power for laser current feedback control. However, adding an extra beamsplitter in high-sensitivity, auto-balanced systems can introduce non-common-mode noise paths, which limits the effectiveness of balanced detection.

Accordingly, there is a need for a method to provide laser power control feedback without disturbing the balance of signal and reference beams. In circuits using an analog subtraction approach, tapping a small fraction of the reference photodiode current—rather than adding an extra optical element—can supply a feedback signal while preserving common-mode noise cancellation. This tap should sample the downstream optical path (i.e., after primary optical elements and beam splitting) to include etalon effects or component-induced absorption features in the feedback loop. At the same time, the tap must minimally affect the reference current required for balanced subtraction.

The present invention addresses this need by implementing a fractional current mirror tap within the existing auto-balanced detection circuit. Instead of adding an optical detection path, the system diverts a set fraction of the reference photocurrent—on the order of 5% to 10%—before that current enters the balanced analog subtraction stage. A scaled transistor pair configured as a current mirror accomplishes this tap, allowing only a fixed portion of the reference photodiode current to flow toward a secondary transimpedance amplifier (TIA) and into the laser driver feedback loop.

In one embodiment, the fractional current mirror tap is situated between the reference photodiode and the balanced subtraction circuit's transistor pair. Most of the photodiode current continues to the primary subtraction node, maintaining the reference arm's function. The diverted current is converted to a voltage by a low-noise TIA, digitized by an analog-to-digital converter, and used to modulate or adjust the laser source drive current. Through this feedback mechanism, slow drifts and broad background slopes in the measured absorption spectra are further reduced, improving long-term averaging and detection sensitivity.

By sampling the reference beam downstream of key optical elements, the scheme takes into account any drift-inducing factors such as beam alignment changes, lens coating reflections (etalons), or partial absorption in intervening components. This allows the laser feedback loop to respond to the same noise sources affecting the spectroscopy measurement, ensuring that long-term intensity drift is corrected at the source. Because the design does not require an additional beamsplitter or photodiode, it avoids introducing non-common-mode noise paths.

Experimental results show that implementing a fractional current mirror tap within an auto-balanced detection system can reduce broad sloping backgrounds by an additional 10-20 dB. In applications such as trace gas detection of methane, ethylene oxide, or hydrogen sulfide, the resulting stability supports lower detection limits and faster averaging times. While the laser architecture and optical setup may remain consistent with existing cat's-eye external cavity or similar tunable laser systems, the fractional current mirror tap improves overall performance.

In summary, the present invention extends prior auto-balanced detection techniques by providing a power control feedback path that samples the reference photodiode output without degrading common-mode noise suppression. Variants of this design may use different fixed fractions for the current mirror tap, alternate transistor or resistor configurations to optimize scaling, or application-specific integrated circuit (ASIC) implementations. In all cases, the approach remains the same: divert a portion of the reference detector current to the laser driver to stabilize the output power against drift.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows the electro optics of the spectroscopy system including the tunable laser and autobalanced detection circuit; and

FIG. 2 is a circuit diagram of an autobalanced detection circuit used in the system.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

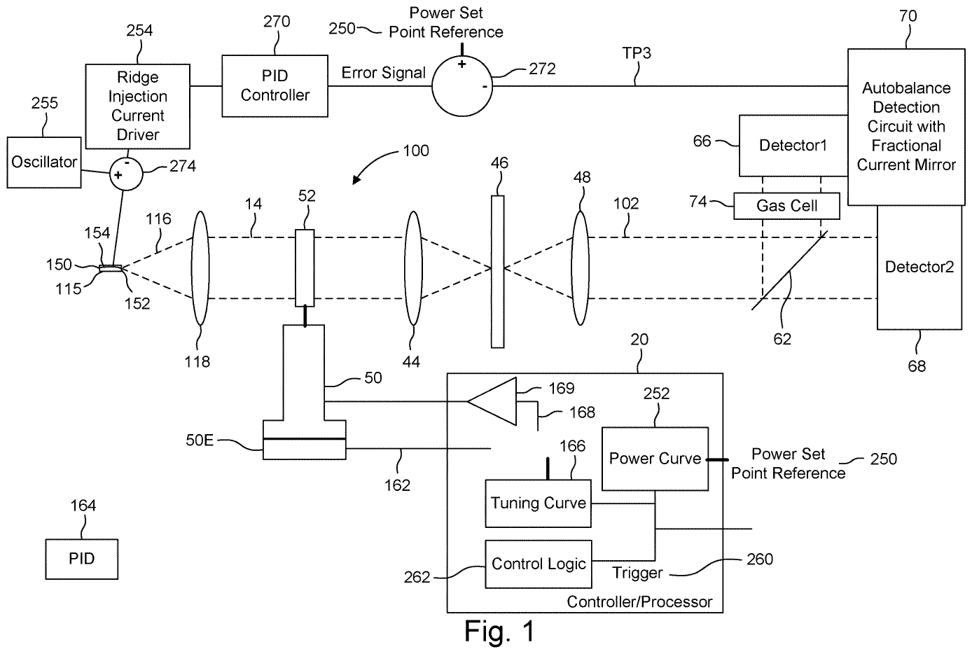

FIG. 1 shows a tunable laser 30 and detectors 66 and 68 and the layout of the electro optical system.

The tunable laser light source comes from gain chip 115 and passes through an external cavity defined by the mirror output coupler 46.

Other material systems can be selected for the gain chip 115 besides InP, however. Common material systems are based on III-V semiconductor materials, including binary materials, such as GaN, GaAs, InP, GaSb, InAs, as well as ternary, quaternary, and pentenary alloys, such as InGaN, InAlGaN, InGaP, AlGaAs, InGaAs, GaInNAs, GaInNAsSb, AlInGaAs, InGaAsP, AlGaAsSb, AlGaInAsSb, AlAsSb, InGaSb, InAsSb, and InGaAsSb. Collectively, these material systems support operating wavelengths from about 400 nanometers (nm) to 2500 nm, including longer wavelength ranges extending into multiple micrometer wavelengths. Semiconductor quantum well, quantum cascade and quantum dot gain regions are typically used to obtain especially wide gain and spectral emission bandwidths, and support operation up to 250 μm in wavelength, or more. Quantum well layers may be purposely strained or unstrained depending on the exact materials and the desired wavelength coverage.

In one example, the gain chip 115 amplifies light in the wavelength range of about 1500-1800 nanometers. The preferred chip architecture is termed a single angled facet (SAF) edge-emitting chip. As such, it has a high reflectivity (HR) coated rear facet 150. It has an antireflective (AR) coated front facet 152. In addition, for improved performance, it has a curved ridge waveguide 154 that is perpendicular to the rear facet but is angled at the interface with the front facet. This angling at the front facet along with the AR coating reduces reflections at the front facet reflectivity by up to 40 dB and significantly improves laser performance by reducing parasitic reflections that can otherwise lead to non-smooth tuning and mode-hopping.

Other gain chips can be used, in other examples, such as double angled facet chips, and non-angled chips.

Preferably its center wavelength is around 1700 nanometers +/−100 nanometers.

The diverging beam 116 from the chip 115 is collimated by a collimating lens 118. The collimated beam 14 is received by a cat's eye focusing lens 44, which focuses the light onto a cat's eye mirror/output coupler 46. This defines the other end of the laser cavity, extending between the mirror/output coupler 46 and the back/reflective facet of the gain chip in the package 114. Note that in most embodiments, cavity length is between 10 mm and 150 mm in length.

Other output couplers can be used such as intracavity beamsplitters.

The collimated light between the collimating lens 118 and the cat's eye focusing lens 44 passes through a bandpass interference filter 52 that is angle tuned in the beam by a tilt actuator such as a galvanometer 50.

In the present design, the free spectral range of the tunable filter 52 is preferably greater than 200 nanometer and is preferably over 300 nm such as about 350 nm.

In some embodiments, the system sweeps through a wavelength scanning range of at least 200 nm. Often the system sweeps through a band of about 1600 nm to about 1800 nm.

Despite the wide range of the tunable filter, it may be preferable to limit the sweep range of the galvanometer as to reduce the sweep width in nanometers, thereby allowing more passes over the same spectral features in a given time interval. Thus in some examples or modes of operation, the scan range is less than 100 nm or even less than 50 nm such as 25 nm or less or 15 nm or less, or less than 10 nm.

The so-called effective refractive index of the tunable filter 52 is preferably greater than 1.50, and is ideally higher than 1.60, such as 1.65.

The passband for the filter is preferably between 1 and 3 nanometers (nm), and more narrowly between 1.5 and 2.5 nm, FWHM. In one design, it is 2 nm. But, in operation, linewidth narrowing (~4×) reduces this in the laser cavity for the effective laser linewidth.

These general design parameters yield a large number of longitudinal modes under the envelope for the filter linewidth for a laser cavity length of 50 mm. In the preferred embodiment, there are at least 15 modes under the filter envelope and at least 5 modes for linewidth narrowed emission to 0.5 nm. Ideally, there are at least 25 modes and possibly 37 modes or more and at least 7 modes to 10 or more modes for linewidth narrowed emission.

This large number of modes works well for low noise spectral analysis. And keep in mind that the larger the number of modes, the lower the modal noise (by sqrt (number of modes)).

The bandpass filter 52 is held on an arm of tilt actuator 50. This allows for tilting of the bandpass filter in the collimated beam to thereby tilt tune the filter and thus change the passband to thereby scan or sweep the wavelength of the swept laser 100.

In the illustrated example, the tilt actuator is a servo galvanometer. In other examples, the angle control actuator 50 is a servomotor or an electrical motor that continuously spins the bandpass filter 52 in the collimated beam 14. This allows for tilting of the bandpass filter 52 with respect to the collimated beam 14 to thereby tilt-tune the filter and thus change the passband to scan or sweep the wavelength of the swept laser.

Tuning speed specifications for galvanometer generally range from 0.1 Hz to 50 kHz. For the higher speeds, a 25 kHz resonant galvo can be used with bi-directional tuning, but higher and lower speeds can be used. Wavelength tuning speed is usually given in nm/sec. In general, the tuning speed should be between 3000 nm/sec and 11000 nm/sec.

The size of the collimated beam is important for many applications. As a general rule, a smaller beam results in higher divergence resulting in a larger cone half angle (CHA), which is the divergence of the beam hitting the tunable filter. This reduces the minimum line width over angle for a tunable filter. In the current embodiment, the CHA must be smaller than a given amount, typically 0.025 degrees, in order to maintain both linewidth and loss.

Note that a higher divergence beam has a smaller diameter, so this means we have to have collimated beams of a large enough diameter to provide the required maximum CHA, and larger beams require physically larger tunable filters. A beam size of ~1 millimeters (mm) is typical for a CHA of 0.025 degrees, but because the beam from the chip is elliptical this should be chosen to be the smaller axis beam). Moreover, the final output collimating lens 48 that forms a telescope from the cat's eye focusing lens 44 can be configured to have an output beam of whatever desired diameter desired, with the magnification given by the ratio of the output lens focal length to the focusing lens focal length. Note that if desired, the elliptical output beam is circularized with the use of anamorphic prism pairs, a pair of cylindrical lenses, or a simple spatial filter at the output, in different examples.

In any event, the beam size of beam 14 for the small axis at the tunable filter 52 is preferably between 0.5 and 2 mm.

The light from the gain chip 115 is polarized. In the common architectures, the polarization is horizontal or parallel to the epitaxial layers of the edge-emitting gain chip. In the preferred configuration, the filter is oriented to receive the S polarization in order to maintain narrow line width of the filter as it is tilt tuned. On the other hand, the P polarization broadens drastically at large tilt angles. S polarization has higher loss at larger tilt angles than P. So, the filter design needs to address these issues by providing a low enough loss across the tuning band for S.

In general, the present cat's-eye configuration provides a number of advantages. It provides low loss, low tolerance, repeatable stable operation since lower angle wavelength change over grating-based lasers.

The mirror/output coupler 46 will typically reflect less than 90% and preferably about 80% of the light back into the laser's cavity and transmits greater than 10% and preferably about 20% of light. Often, the transmitted light is collimated with the help of the output collimating lens 48. More generally, the mirror/output coupler can reflect from 10% to 99% of light (transmitting 90% to 1%, respectively), depending on the output power and laser cavity loss desired. Higher reflectivity results in lower loss cavities and thus wider laser tuning range where gain exceeds loss, but results in lower output power.

In some embodiments, an iris or mask is added typically after the output coupler to clip the beam edge. This reduces power fluctuations as the beam wanders due to refraction in the tilting bandpass filter.

The portion of the beam passing through the output coupler 46 is collimated by output collimating lens 48 and is divided into two beams by beamsplitter 62 in order to produce a signal beam and reference beam for the auto balanced detection circuit.

Beamsplitter 62 is chosen such that the signal beam power is proportionally stronger than the reference beam power in order to allow for common-mode noise subtraction by the autobalance detection circuit. The beamsplitter will direct from 55% to 80% of the light into the reference arm (45% to 20% to the signal arm respectively). More power is required in the reference arm for the autobalancing circuit to function, but excessive reduction in the signal arm power ultimately reduces signal.

The signal beam passes through the gas cell containing the sample. The gas cell can be a single-pass cell, a multi-pass cell, or any other vessel that contains a sample of interest. The signal beam then hits the sample photodetector, detector1 66. The reference beam bypasses the gas cell directly to the reference photodetector, detector2 68.

The autobalance detection circuit 70 performs analog current subtraction from the photocurrents generated by detector1 66 and detector2 68. The circuit uses an integrating feedback loop formed by an operational amplifier in an inverting transimpedance amplifier mode and a matched bipolar junction transistor pair to automatically regulate the photocurrent of detector2 68 in order to drive the subtraction node current to approximately zero, thereby subtracting common mode noise and leaving only signal generated by the signal beam passing through the gas cell 64.

The spectroscopy device is measured at the output TP2 of the autobalance detection circuit 70 in order to determine the presence or concentration of a sample of interest.

The combination of a narrow wavelength sweep, which improves the rate of data collection at the wavelengths of interest in some embodiments, and the autobalance detection circuit 70, which subtracts common mode noise between the signal and reference detector, improves the sensitivity of the spectroscopy device greatly.

The fractional current mirror is used to provide a voltage (TP3) that is used for current feedback for the laser, based on the PID controller 270 and power set point reference 250. The PID controller 270 controls a ridge injection current driver 254 providing current to the chip 115.

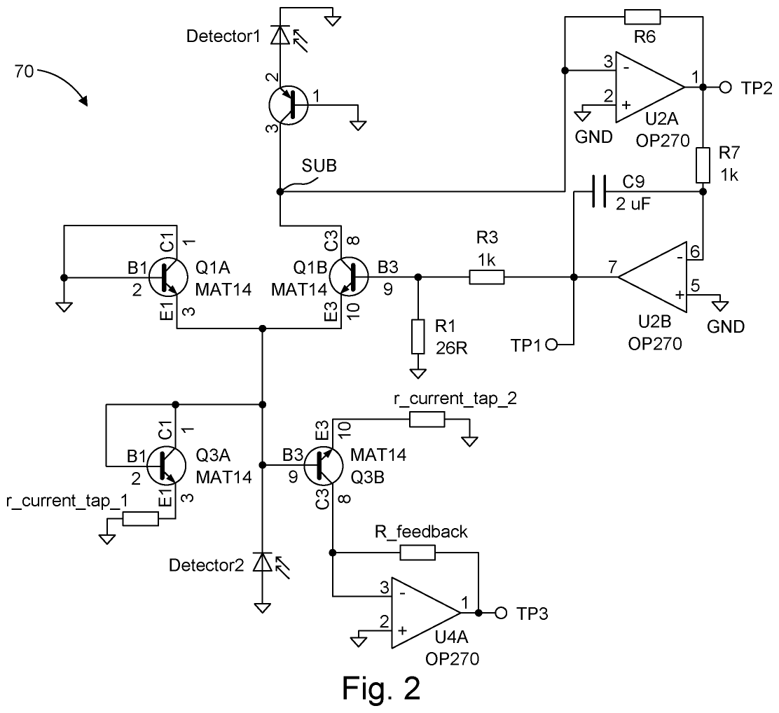

FIG. 2 illustrates one implementation of the auto-balanced detection circuit (e.g., circuit 70 of FIG. 1) including a fractional current mirror tap for laser power control. The upper photodetector (detector1) receives the signal beam (e.g., the beam that has interacted with the sample) and generates a signal photocurrent. The lower photodetector (detector2) receives a reference beam that bypasses the sample and generates a reference photocurrent representative of instantaneous laser intensity.

The signal photocurrent and a scaled reference photocurrent are combined at a subtraction/summing node coupled to a current-to-voltage conversion stage implemented with operational amplifier U2A. U2A is configured as a transimpedance stage with a feedback impedance R6 and provides, at node TP2, an output voltage proportional to a residual current corresponding to a difference between the signal photocurrent and the scaled reference photocurrent. Accordingly, common-mode intensity fluctuations present in both detector currents are substantially canceled at TP2 when the scaling is properly adjusted.

An automatic balancing loop adjusts the scaling applied to the reference photocurrent. In the illustrated embodiment, operational amplifier U2B, together with input resistor R7 and integrating capacitor C9, forms an integrating servo that drives a control node TP1. The control node TP1 biases the matched transistor pair Q1A/Q1B (e.g., via resistor R3) to regulate the effective reference-current contribution at the subtraction node SUB such that a low-frequency component of the residual current at TP2 is driven toward a null condition. Reference photocurrent from detector2 enters a node coupled to the emitters of Q1A/Q1B. Q1A provides a return path, while Q1B steers an adjustable fraction of the reference current into the subtraction node. The integrator adjusts the base drive of Q1B so that the steered reference current matches the signal-arm current (in the common-mode/low-frequency sense), canceling intensity noise at TP2.The integrating loop drives the DC and/or low-frequency component of the residual difference at TP2 toward approximately zero (or toward a defined offset), thereby maximizing common-mode rejection over the servo bandwidth while leaving higher-frequency spectroscopy content substantially uncorrected. This maintains high common-mode rejection for slow laser intensity drift while preserving higher-frequency spectroscopy content at TP2.

To generate a laser power feedback signal without introducing an additional optical tap, a fractional current mirror is coupled to the reference photodetector current. In the illustrated embodiment, matched transistors Q3A and Q3B form the fractional current mirror. Q3A is coupled in a reference configuration and Q3B provides a mirrored tap current. Emitter-degeneration resistors r_current_tap_1 and r_current_tap_2 set a mirror ratio so that a selected fraction of the reference photocurrent is mirrored as a tap current while the remaining reference current continues to participate in the auto-balanced subtraction. The tap fraction may be about 1% to 20%, more preferably about 5% to 10%. The fraction can be set by an emitter-resistor ratio (r_current_tap_1:r_current_tap_2), by transistor area ratio, or by a combination.

The tap current is converted to a voltage by transimpedance amplifier U4A with feedback resistor R_feedback, thereby producing a power monitor signal at node TP3. The power monitor signal TP3 is provided to a laser power control loop (e.g., the power-control feedback shown in FIG. 1) to adjust the laser drive current and reduce slow intensity drift and baseline slope in the measured spectra, while avoiding additional optical components that would otherwise degrade the balanced detector's common-mode noise rejection. Because the tap is derived from the reference photodetector current at the same node used by the autobalance loop, TP3 tracks downstream optical-path variations (e.g., etalons or alignment drift) without adding an additional optical pickoff. TP3 may be filtered and/or digitized and used in an analog or digital feedback controller that adjusts laser drive current.

While this invention has been particularly shown and described with references to preferred embodiments thereof, it will be understood by those skilled in the art that various changes in form and details may be made therein without departing from the scope of the invention encompassed by the appended claims.

What is claimed is:

1. A tunable laser spectroscopy system comprising:
a tunable laser source configured to emit a laser beam and to tune the beam wavelength across a scan range;
an optical splitter configured to split at least a portion of the beam into a signal beam and a reference beam;
a sample region positioned in the signal beam path;
a first photodetector configured to receive the signal beam and produce a signal photocurrent, and a second photodetector configured to receive the reference beam and produce a reference photocurrent;
an auto-balanced detection circuit coupled to the first and second photodetectors and configured to generate a measurement output by subtracting photocurrents while automatically adjusting a scaling of one of the photocurrents using a feedback loop to reduce common-mode intensity noise.

2. The system of claim 1, wherein the sample region is a gas cell.

3. The system of claim 1, further comprising a fractional current-mirror tap coupled to the reference photocurrent and configured to divert a fraction of the reference photocurrent and to generate a power monitor signal from the diverted fraction and a controller configured to adjust a drive current of the tunable laser source based on the power monitor signal to regulate optical output power.

4. The system of claim 3, wherein the power monitor signal is generated electrically from the second photodiode current and does not require an additional beamsplitter or additional photodiode beyond those used for the auto-balanced detection circuit.

5. The system of claim 1, wherein the scan range is less than 25 nm.

6. The system of claim 1, wherein the scan range is greater than 200 nm.

7. The system of claim 1, wherein the tunable laser is a cat's-eye external cavity laser including a transmissive, tilt-tuned interference filter.

8. An auto-balanced photodetection circuit comprising:
a first input configured to receive a first photocurrent from a first photodetector and a second input configured to receive a second photocurrent from a second photodetector;
a subtraction node at which the first photocurrent and a scaled contribution of the second photocurrent are combined;
a first amplifier stage coupled to the subtraction node and configured to generate a measurement output signal representative of a residual difference between the first photocurrent and the scaled contribution of the second photocurrent;
a controllable current scaling circuit coupled to the second input and configured to provide the scaled contribution of the second photocurrent at the subtraction node;
an integrating feedback loop coupled to the measurement output signal and configured to control the controllable current scaling circuit to reduce a DC and/or low-frequency component of the residual difference; and
a fractional current mirror coupled to receive the second photocurrent and configured to divert a fraction of the second photocurrent to generate a tapped current, and a second amplifier stage configured to convert the tapped current into a power monitor output.

9. The circuit according to claim 8, wherein the first amplifier stage comprises a transimpedance amplifier including an operational amplifier and a feedback impedance.

10. The circuit according to claim 8, wherein the controllable current scaling circuit comprises a matched transistor pair arranged to controllably mirror and/or steer the second photocurrent to the subtraction node in response to a control signal.

11. The circuit according to claim 8, wherein the integrating feedback loop comprises an operational amplifier and an integrating capacitor arranged to generate an integrated control signal that controls the controllable current scaling circuit.

12. The circuit according to claim 8, wherein the fractional current mirror comprises a matched transistor pair and emitter-degeneration resistors configured to set the fraction, and wherein the fractional current mirror is coupled such that a remaining portion of the second photocurrent is supplied to the subtraction node via the controllable current scaling circuit.

13. The circuit according to claim 8, wherein the fraction diverted by the fractional current mirror is between 5% and 10% of the second photocurrent, and wherein the power monitor output is provided at an output terminal configured for coupling to a controller that regulates a drive current of a laser source.

14. A method of performing tunable laser absorption spectroscopy comprising:
tuning a laser source across a wavelength scan range;
splitting the laser beam into a signal beam and a reference beam;
passing the signal beam through a sample region and detecting the signal beam with a first photodetector to generate a signal photocurrent;
detecting the reference beam with a second photodetector to generate a reference photocurrent; and
generating a measurement signal by subtracting a scaled version of one of the photocurrents from the other photocurrent, and automatically adjusting the scaling using an integrating feedback loop to reduce common-mode intensity noise.
